(19) United States
(12) Patent Application Publication
(10) Pub. No.: US 2005/0055962 A1
(43) Pub. Date: Mar. 17, 2005

(54) Supplemental door trim

(76) Inventor: Mike S. McElroy, Mountain View, CA (US)

Correspondence Address: LITMAN LAW OFFICES, LTD., P.O. BOX 15035 CRYSTAL CITY STATION, ARLINGTON, VA, 22215, US

(21) Appl. No.: 10/659,347

(22) Filed: Sep. 11, 2003

(51) Int. Cl. E06B 1/04

(52) U.S. Cl. 52/716.1

(57) ABSTRACT

A supplemental door trim that is configured to fit to an existing door molding, comprising a plurality of elongated trim sections. Each trim section has a cross-section comprising a base portion and an integral arm section. The base portion further comprises an upper base portion. The integral arm section extends from the upper base portion and is adapted to overlay an existing door molding with a setback. In one embodiment the base portion and extended arm section are integrated and define a single elongated trim section. In another embodiment the integral arm section is configured to have a flat face or a variable face to provide a more stylish look to the supplemental door trim.

### BACKGROUND OF THE INVENTION

1. Field of the Invention

The present invention relates to a structure to cover a door molding. More specifically, the invention is a supplemental door trim configured for installation to an existing door molding.

2. Description of the Related Art

A track-housing boom took place in the 1960s, 1970s, and 1980s. Construction of houses during the track-housing boom was characterized in part by contractors who saved costs by installing basic level trim inside the newly constructed houses. The existing door molding (sometimes known as door casing) around interior doors consisted for the most part of unattractive low grade 1×⅝″ beveled wood molding. Removing the existing door molding is messy and time consuming. Thus, there is a need to for an easy way of updating an existing door molding that does not involve the mess and inconvenience of replacing the molding.

A review of the prior art follows.

U.S. Pat. No. 5,412,909 issued May 9, 1995 to Ming-Hsin Wu, describes a plastic casing to cover an existing door casing or molding. The structure mainly uses a combination of front and rear slats that are fitted together so as to cover up the outer layer of the existing old casing. The width of the structure can be adjusted to the width of the old casing. The '909 structure uses numerous interlocking slats that are time consuming to install over an existing door molding.

U.S. Pat. No. 6,357,187 issued Mar. 19, 2002 to M. K. Haldeman, describes a device for protecting the edge of a doorway. The '187 device includes opposing contact edges that extend around the edge of a doorway to contact and grip opposing walls adjacent the doorway. The '187 device is not decorative and if used to supplement or replace an existing door molding would result in a particularly unattractive door molding.

U.S. Pub. No. 20030041552 published Mar. 6, 2003 to Hartley et al, describes a removable and reusable door frame guard for installation over and providing temporary protection to door trim attached to a door jamb. The guard includes a relatively rigid elongate upright member of shock absorbing material with an L-shaped cross section for covering adjacent bottom, front and inside portions of a vertical door jamb to be protected, and an expandable clamp means is secured to an upper end of the upright member and dimensioned in position for expanding and thereby engaging a bottom surface of a horizontal door header to hold the upright member in position. The '552 guard does not solve the problem of updating an unattractive existing door molding.

None of the above inventions and patents, taken either singly or in combination, is seen to describe the instant invention as claimed. Thus a supplemental door trim solving the aforementioned problems is desired.

### SUMMARY OF THE INVENTION

A supplemental door trim that is configured for covering an existing door molding, comprising a plurality of elongated trim sections. Each trim section has a cross-section comprising a base portion and an integral arm section. The base portion further comprises an upper base portion. The integral arm section extends from the upper base portion and is adapted to overlay an existing door molding with a setback. In one embodiment the setback is about 0.25 inches (about ¼″) to accommodate existing door hinges. In another embodiment the base portion and extended arm section are integrated and define a single elongated trim section. In still another embodiment the integral arm section is configured to have a flat face or a variable face to provide a more stylish look to the supplemental door trim.

Accordingly, it is a principal object of the invention to provide a supplemental door trim that is configured for installation to an existing door molding.

It is another object of the invention to provide a supplemental door trim that obviates the need to replace the existing door molding thereby saving considerable labor and mess that is normally associated with replacing the existing door molding.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A shows a worker installing a supplemental door trim, according to the invention, to an existing door molding around a door.

FIG. 1B shows another view of the supplemental door trim of FIG. 1B

FIG. 2 shows a prior art cross-section of an existing traditional door trim.

FIG. 3 shows a cross-section of a supplemental door trim with a flat face, according to the invention, fitted to an existing door molding.

FIG. 4 shows a cross-section of a supplemental door trim with a variable face, according to the invention, fitted to an existing door molding.

FIG. 5 shows an exploded view of a supplemental door trim according to the invention fitted to an existing door molding.

Similar reference characters denote corresponding features consistently throughout the attached drawings.

### DETAILED DESCRIPTION OF THE PREFERRED EMBODIMENTS

The present invention relates to a structure to cover a door molding. More specifically, the invention is a supplemental door trim configured for installation to an existing door molding with a setback of about 0.25 inches (about ¼″). It should be understood that the terms “door molding” and “door casing” are regarded hereinafter as equivalent terms.

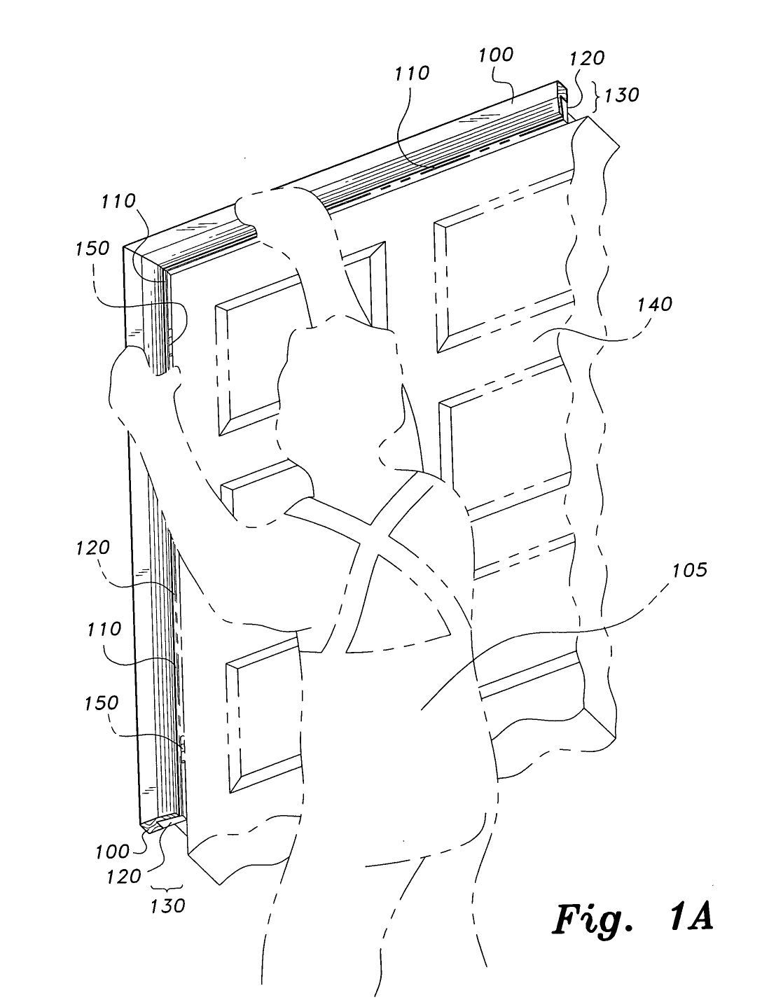

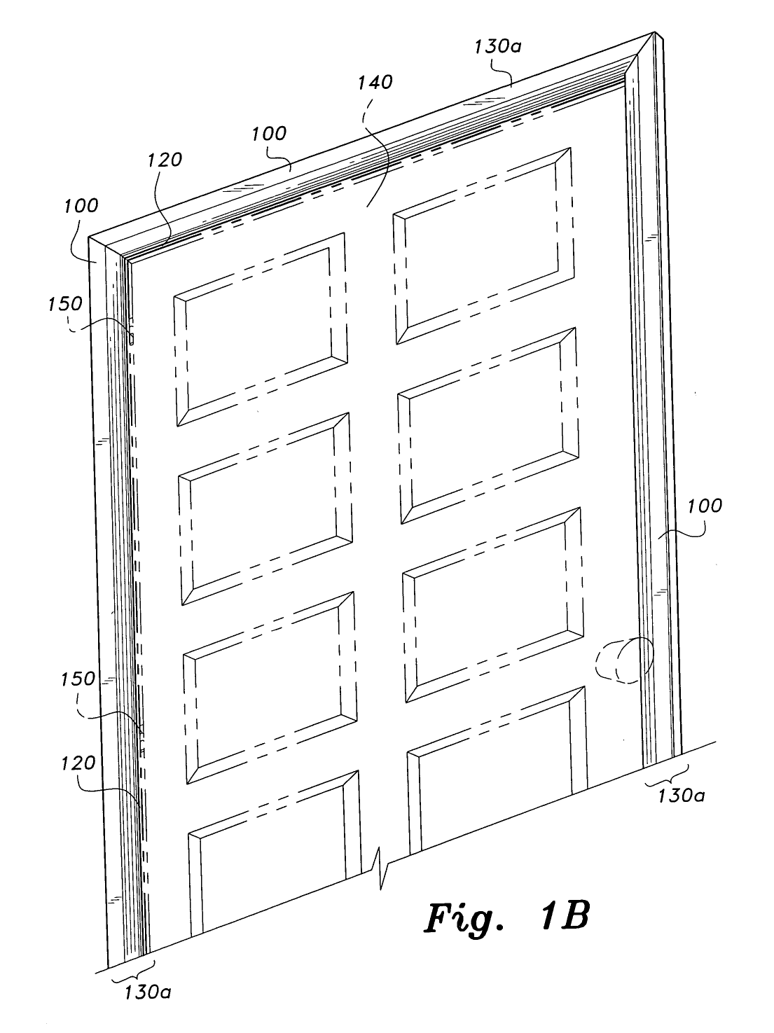

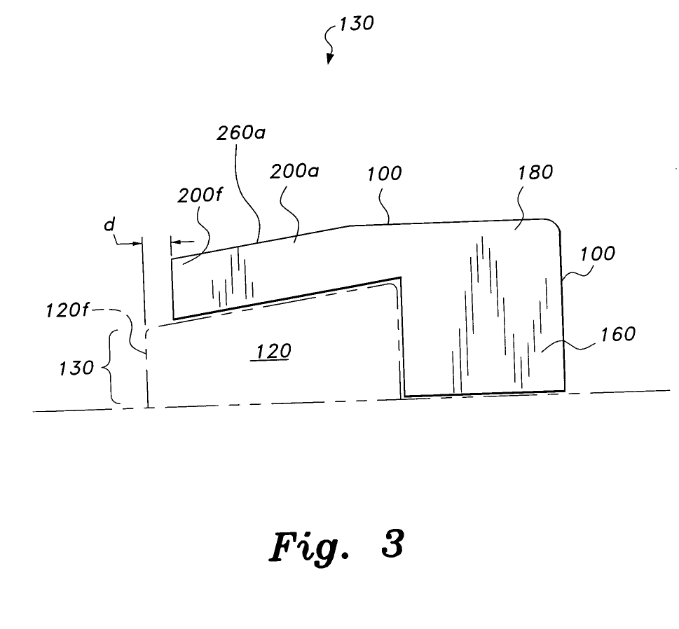

FIG. 1A shows a worker 105 installing a supplemental door trim 100, according to the invention, to an existing door molding 120 to provide an upgraded door trim 130 located around a door 140. The supplemental door trim 100 is configured for installation to the door molding 120 with a setback 110 (see, e.g., FIG. 3). The setback may vary; in one embodiment the setback is about ¼″ to avoid the supplemental door trim 100 clashing with existing door hinges 150. The setback 110 can help obviate the need to cut out sections from the trim 100 to accommodate the existing hinges 150 thereby allowing the worker 105 to effortlessly and quickly install the supplemental door trim 100 to the door molding 120 to provide the upgraded door trim finish 130. A setback 110 of about 0.25 inches (about ¼″) is normally sufficient to avoid clashes with the existing door hinges 150. The setback 110 also serves to provide a desired aesthetic look wherein the supplemental door trim 100 and door molding 120 appear to form a one-piece look continuous structure represented by numeric 130a in FIG. 1B.

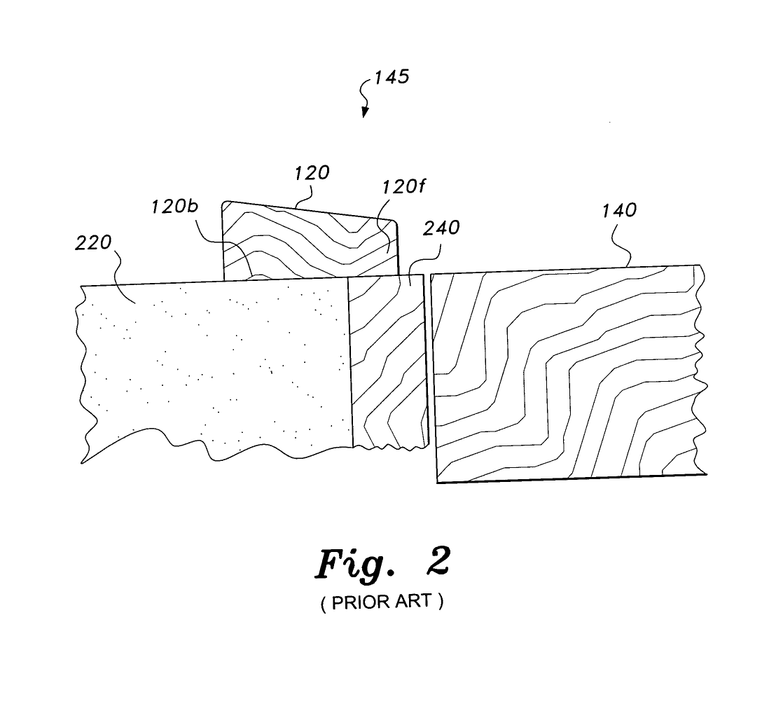

FIG. 2 shows a prior art cross-section of a traditional door trim 145 comprising the existing door molding 120. In more detail, the bottom 120b of the traditional door molding 120 is attached to a wall 220; a front portion 120f of the existing molding 120 abuts against a doorjamb 240. It should be understood that the traditional door molding 120 is of very simple design and adds very little to the aesthetics of the door 140.

FIG. 3 shows a cross-section of the upgraded door trim 130 comprising a first embodiment of the supplemental door trim 100, according to the invention, attached to the existing door molding 120. In more detail, the supplemental door trim 100 comprises a base portion 160 with an upper base portion 180, and an integral arm section 200a integral with and extending from the upper base portion 180 to at least partly overlay the existing door molding 120. The integral arm section 200a is setback from the front 120f of the existing molding 120 by a distance “d”; “d” is about ¼″to accommodate existing door hinges 150. In this embodiment of the invention, the integral arm section 200a has a flat face 260a.

It will be understood that the design of the supplemental door trim 100 is configured to enable a worker 105 to position the base portion 180 to abut against the existing molding 120 and cause the integral arm section 200a to align and fit snuggly on top of the molding 120. In this respect the supplemental door trim 100 is self-aligning and consequently easy to install around a door 140 to provide an upgraded door trim 130.

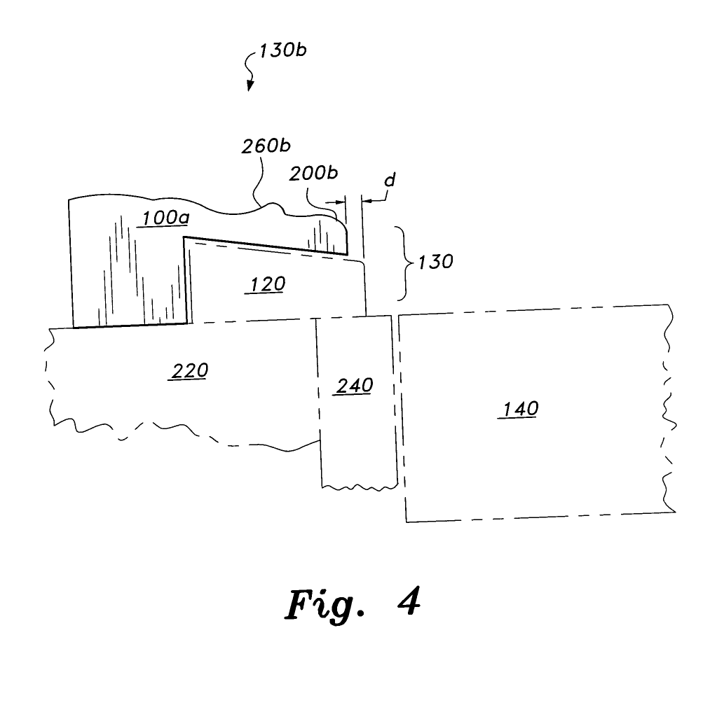

FIG. 4 shows a cross-section of an upgraded door trim 130b comprising a second embodiment of the supplemental door trim 100 (represented as numeral “100a”), according to the invention, attached to the existing door molding 120. In more detail, the supplemental door trim 100a comprises a base portion 160a with an upper base portion 180a, and an integral arm section 200b integral with and extending from the upper base portion 180a to at least partly overlay the existing door molding 120. The integral arm section 200b is setback from the front 120f of the existing molding 120 thereby defining the setback 110 of distance “d”; “d” is about ¼″ to accommodate existing door hinges 150. In this embodiment of the invention, the integral arm section 200b has an upper surface 260b that is configured with a variable profile to provide different style options in place of a simple flat face 260a as shown in FIG. 3.

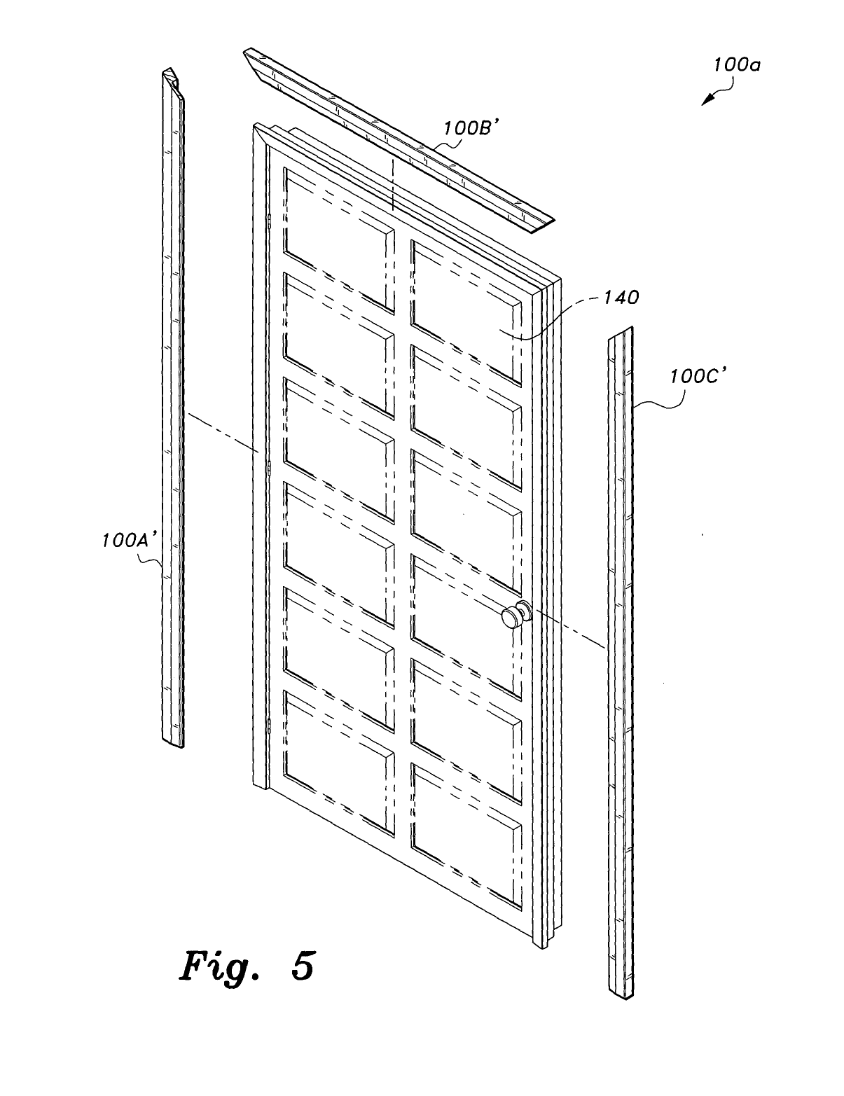

The supplemental door trim 100 may be supplied in seven-foot (7′) sections. The supplemental door trim 100 is then cut to size and fitted to the existing door molding 120. FIG. 5 shows an exploded view of a supplemental door trim 100a cut to size and fitted to an existing door molding 120. The supplemental door trim 100a is shown in three sections cut from a single elongated piece of supplemental door trim 100: 100A′, 100B′, and 100C. Each cut section comprises a base portion 160 with an upper base portion 180, and an integral arm section 200 integral with and extending from the upper base portion 180 that is configured to at least partly overlay the existing door molding 120. The integral arm section 200 is setback from the front 120f of the existing molding 120 thereby defining the setback 110 of distance “d”; “d” is about ¼″ to accommodate existing door hinges 150.

The supplemental door trim 100 is made of any suitable material such as wood or medium density fiber board (MDF) and can be nailed using finish nails or stuck to the existing molding 120 using a suitable wood or MDF adhesive. The supplemental door trim 100 and existing molding 120 can be collectively painted or wood stained to create the preferred one-piece look 130a (FIG. 1B).

Care should be taken to avoid accidental inhalation of dust when sanding down the product 100 by using, e.g., a suitable dust mask. Installation of the supplemental door trim 100 can be aided by using a miter box or power miter saw. Caulking all joints gives a one-piece appearance (see FIG. 1B).

It is to be understood that the present invention is not limited to the embodiments described above, but encompasses any and all embodiments within the scope of the following claims.

1. A supplemental door trim that is configured to fit over an existing door molding, comprising:
an elongated trim section, the trim section having a cross-section comprising,
a base portion, wherein the base portion comprises an upper base portion, and
an integral arm section, the integral arm section extends from the upper base portion and overlays an existing door molding.

2. The supplemental door trim according to claim 1, wherein the supplemental door trim is made of a material selected from the group consisting of wood and medium density fiber board.

3. The supplemental door trim according to claim 1, wherein the integral arm section defines a setback of about 0.25 inches upon contact with an existing door molding.

4. The supplemental door trim according to claim 1, wherein the integral arm section defines a flat face.

5. The supplemental door trim according to claim 1, wherein the integral arm section defines a variable face.

6. The supplemental door trim according to claim 1, wherein the elongated trim section is about seven foot in length or cut from a piece of elongated trim section about seven foot in length.

7. A supplemental door trim that is configured to fit over an existing door molding, comprising:
a plurality of elongated trim sections, each trim section having a cross-section comprising,
a base portion, wherein the base portion comprises an upper base portion, and
an integral arm section, wherein the integral arm section extends from the upper base portion and is adapted to overlay an existing door molding;
whereby the supplemental door trim obviates the need to replace the existing door molding thereby saving considerable labor and mess associated with replacing the existing door molding.

8. The supplemental door trim according to claim 7, wherein the supplemental door trim is made of a material selected from the group consisting of wood and medium density fiber board.

9. The supplemental door trim according to claim 7, wherein the integral arm section defines a setback of about 0.25 inches upon contact with an existing door molding.

10. The supplemental door trim according to claim 7, wherein the integral arm section defines a flat face.

11. The supplemental door trim according to claim 7, wherein the integral arm section defines a variable face.
